(19) United States
(12) Patent Application Publication
(10) Pub. No.: US 2014/0166198 A1
(43) Pub. Date: Jun. 19, 2014

(54) METHOD FOR PRODUCING A CONNECTION DEVICE FOR USE IN THE NEGATIVE PRESSURE TREATMENT OF WOUNDS

(71) Applicant: Paul Hartmann AG, Heidenheim (DE)

(72) Inventors: Axel ECKSTEIN, Heidenheim (DE); Pierre CROIZAT, Herbrechtingen (DE); Ali SAGAS, Kfar-Kama (IL); Oded STEIN, Kfar Hahoresh (IL)

(73) Assignee: Paul Hartmann AG, Heidenheim (DE)

(21) Appl. No.: 13/962,490

(22) Filed: Aug. 8, 2013

Related U.S. Application Data
(60) Provisional application No. 61/681,359, filed on Aug. 9, 2012.

(30) Foreign Application Priority Data
Aug. 9, 2012 (DE) 10 2012 214 175.8

(51) Int. Cl. B29C 45/14; B29C 65/48

(52) U.S. Cl. CPC B29C 45/14598; B29C 65/48
USPC 156/245; 264/279; 264/129

(57) ABSTRACT

A method for producing a connection device for use in the negative pressure therapy of wounds, includes introducing a flexible conduit into an injection mold, the conduit being constructed for impingement with negative pressure and/or fluid media, and comprising at least two lumens, forming a coupling body at an end section of the conduit by injection molding an elastomeric material to the end section of the conduit, said coupling body being constructed for attachment to a negative pressure bandage which covers the wound and seals the wound tight against the environment, said the conduit being constructed for communication with the wound space through at least one opening, and attaching and fastening an end cap to the coupling body, thereby sealing the coupling body tight to the outside.

### CROSS-REFERENCES TO RELATED APPLICATIONS

This application claims the benefit of prior filed U.S. provisional Application No. 61/681,359, filed Aug. 9, 2012, and of German Patent Application, Serial No. 10 2012 214 175.8, filed Aug. 9, 2012, pursuant to 35 U.S.C. 119(e), the disclosure of which is incorporated herein by reference.

### BACKGROUND OF THE INVENTION

The invention relates to a method for producing a connection device for use in the negative pressure treatment of wounds.

The following discussion of related art is provided to assist the reader in understanding the advantages of the invention, and is not to be construed as an admission that this related art is prior art to this invention.

In the recent past, the negative pressure treatment of wounds, in particular of problematically healing wounds has gained increasing importance. Negative pressure treatment means that a body or wound area which is exposed to the surrounding atmosphere is sealed against the environment i.e., the atmosphere in which we live and breathe, in a pressure tight or vacuum tight manner, wherein within the sealed wound region a pressure which is lower relative to the atmospheric pressure, i.e. negative pressure can be applied and permanently maintained. Negative pressure in the context of the field at issue here, relates to a negative pressure, which is typically between 0 and 250 mmHg (mm mercury column) below the surrounding atmospheric pressure. It has been shown that this facilitates wound healing. For the negative pressure tight sealing, a negative pressure bandage is provided, which for example can include a pressure tight—or negative pressure tight film layer, which is typically adhesively attached to an uninjured body region that surrounds the wound to achieve a tight sealing. In order to apply and maintain a negative pressure to the wound space by way of a negative pressure generating device, i.e., a vacuum pump in the broadest sense, conduit to which negative pressure can be applied can be used in the systems for negative pressure therapy at issue here, which conduit interact with the negative pressure bandage in order to apply negative pressure to or into the wound space.

DE 10 2009 060 596 A1 discloses a connection device of the aforementioned type. The conduit is attached to the wound averted side of the coupling body and fixed there. For the negative pressure communication with the wound space openings are provided which extend through the walling of the conduit and the coupling body. A similar connection device is known from DE 10 2010 006 272 A1 in which the conduit itself forms a coupling body in that a wound side longitudinal end section of the conduit transitions on both sides one-piece into lateral wing sections. The one-piece configuration i.e., the production of conduit and coupling body in a single manufacturing step is extremely complicated however and therefore disadvantageous.

Further connection devices are known from DE 10 2010 006 273 A1. In this embodiment the conduit s arranged sandwich like between different layers, which form a coupling body toward the wound bandage and are sealingly fixed which also involves great effort.

In WO 2009/124548 it is proposed o produce a rather cup shaped or plate shaped coupling body with radially extending contact areas and with a receiving section for inserting a conduit one-piece in the injection molding method.

It would therefore be desirable and advantageous to provide an improved method for producing a connection device, which can be carried out reliably and economically and is suited for producing flat and flexible connection devices.

### SUMMARY OF THE INVENTION

According to one aspect of the present invention, a method for producing a connection device for use in the negative pressure therapy of wounds, includes introducing a flexible conduit into an injection mold, the conduit being constructed for impingement with negative pressure and/or fluid media, and comprising at least two lumens, forming a coupling body at an end section of the conduit by injection molding an elastomeric material to the end section of the conduit, said coupling body being constructed for attachment to a negative pressure bandage which covers the wound and seals the wound tight against the environment, said the conduit being constructed for communication with the wound space through at least one opening; and attaching and fastening an end cap to the coupling body, thereby sealing the coupling body tight to the outside.

With the method according to the invention the preferably flatly constructed conduit is thus initially provided separate which has the general advantage o allow endless manufacturing by extrusion, wherein subsequent thereto section s of a respectively desired line length can be provided by cutting to length. The coupling body is then formed by molding on to an end section of the conduit and completed by attaching and fastening the end cap. It is especially advantageous that in this type of manufacturing the coupling body a sealing transition to the conduit can at the same time be reliably formed, or in other words that during forming the coupling body the associated and provided conduit is that the same time sealingly joined to the coupling body.

The at least one opening in the walling of the coupling body which walling faces the negative pressure bandage can either be produced during the injection molding process by appropriate configuration of the injection molding tool or in a subsequent work step for example by a punching process. Production by way of injection molding process however is preferred. Preferably, multiple openings are provided which are preferably configured in the shape of oblong holes.

The method according to the invention is also particularly suited for forming a very flat connection device in that the conduit is led approximately parallel to the plane of the two-dimensional extent of the coupling body to be produced. In this context, essentially parallel means a slant of up to 15° in relation to this plane of extent which also forms the contact surface to the negative pressure bandage.

A process sequence is advantageous in which the elastomeric material is molded to the end section of the conduit so that at least one lumen ends freely after injection molding the material of the coupling body around the end section and that by fastening the end cap, the at least one freely ending lumen is sealed tight against the outside. In this variant it is advantageous that during the molding-on of the material that forms the coupling body on the end section of the conduit, fluid conducting sections which are in the following referred to as lumens are formed inside the coupling body. Process technically this is realized in that for example rod-shaped elements are provided inside the injection molding tool which then form these lumens and in particular prevent that during the injection molding process material enters the lumens of the conduit. It is also conceivable however that in the conduit or the end section of the conduit extend as far as the inner side of the end cap and its lumens are then sealingly closed by the end cap.

According another advantageous feature of the invention, the elastomeric material is molded to the end section of the conducting in such a manner that at least two lumens and freely after the molding and that by fastening the end cap the freely ending lumens are closed sealingly towards the outside and are connected to each other so as to be in flow communication, in that the end cap has a recess which connects the at least two lumens with each other. This has the advantage that the lumens of the conduit or the coupling body can be connected to each other at their distal ends and with this in a manner of speaking without dead space. This is particularly advantageous for when the one lumen is intended to function as rinsing lumen because in this case a complete rinsing of the lumens with fluid media in particular air can be insured without the formation of deposits at step space science which cannot or only with difficulty be circulated. The formation of this communication at the distal ends of the lumens by way of fastening and ceiling the end cap offers a very economical way of producing the coupling body or the connection device. It is noted that the end cap itself can be produced as injection molding component in a injection molding process.

According another advantageous feature of the invention, the conduit and/or the coupling body and/or the end cap are formed from a flexible elastomeric material, in particular from silicone or on silicon basis with a shore—A hardness of at most 65, in particular of at most 60, is particular of at most 50 in particular of at most 40, and of at least 10, in particular of at least 15.

For attaching the end cap it is advantageous when the end cap is materially connected with the injection molded material of the coupling body, i.e. in particular and preferably glued to the injection molded material of the coupling body.

According another advantageous feature of the invention, in the method step of the injection molding-on a preferably thin border region is formed into which the end cap is inserted and which then surrounds the end cap collar-like in a circumferential direction. Such a border region which for example has a wall thickness of 0.2 to 1.5 mm can be very easily produced in the injection molding method because it only has to protrude by several few millimeters, for example 1 to 10 mm, in particular 1 to 8 mm, in particular 1 to 5 mm, in order to form a collar like receptacle for the end cap.

According another advantageous feature of the invention, the coupling body can be formed with a first region which includes a first art which at least partially surrounds the end section of the conduit, an intermediate part which adjoins the first part, and the end cap, and with a second region which extends two-dimensionally and is formed with a thickness which is smaller than the thickness of the first region. The mentioned intermediate part of the coupling body results when the end section of the conduit does not essentially extend over the entire longitudinal extent of the first region but forms only a relatively short attachment for molding on the coupling body. In this case, the lumens of the conduit are continued in the interior of the coupling body by channel-forming recesses, which are formed during the injection molding, i.e., lumens. Forming the coupling body with a relatively short first part, which surrounds the end section of the conduit, and the intermediate part adjoining the first part in which intermediate part the lumens of the conduit are continued is preferred. In this case it is advantageous when the end section of the conduit i.e., the region of the conduit which is surrounded with the material of the coupling body by injection molding protrudes into the injection mold is about 2 to 20 mm, in particular 2 to 15 mm and further in particular 3 to 12 mm and further in particular 5 to 10 mm.

According another advantageous feature of the invention, the aforementioned two-dimensionally extending region of the coupling body can be configured to have a thickness of 0.1 to 0.2 mm, in particular 0.1 to 1.5 mm, in particular 0.1-1.0 mm, in particular 0.1-0.8 mm, in particular from 0.1-0.5 mm.

According another advantageous feature of the invention, the two-dimensional extent of the second region is configured so that the contact surface of the second region with the wound-averted topside of the negative pressure bandage is at least 1.5 times, in particular at least 1.8 times the size of the contact surface of the first region with the wound-averted topside of the negative pressure bandage. The contact surface is viewed or calculated in the perpendicular projection to the plane of extent of the coupling body.

According another advantageous feature of the invention, the first region can be configured to have a maximal thickness which is at most 3 mm, in particular at most 2 mm greater than the thickness of the conduit and when the first region is configured to have a thickness which is at most 5 mm, in particular at most 3 mm in particular at most 2 mm greater than the width of the conduit.

According another advantageous feature of the invention, the thickness extent of the conduit can be at most 7 mm, in particular at most 6 mm in particular at most 3 mm and further in particular 4-6 mm, wherein its width transverse to the longitudinal extent is at least 12 mm, in particular at least 15 mm, in particular between 15 mm and 30 mm, in particular between 15 mm and 25 mm, in particular between 15 mm and 22 mm.

According another advantageous feature of the invention, in case of a multi-lumen configuration of the conduit, one of the lumens can be configured significantly greater than the other lumen. The lumen which is configured with a greater conducting cross section is in this case suited as suction lumen for discharge of wound secrete with particle shaped components often contained therein, which suction lumen that can be impinged with negative pressure. In order to prevent collapsing of an in particular flat conduit it can be advantageous to provide supporting means inside a lumen to prevent collapsing, which supporting means preferably extend one-piece from the inner walls of the conduit and thereby define or delimit partial cross sections of a lumen. In this case, it can also be advantageous that two lumens or partial sections of a lumen inside the provided conduit, which lumens or partial sections of a lumen are not separated form each other negative pressure tight are pressure tight sealed against each other in their extension inside the thereby formed coupling body and transverse to their longitudinal extent during the process step of the molding on. Thus according to this further inventive ides lumens are formed inside the coupling body which are separated from each other, which however at the same time can be fluidly connected at their distal ends if this is considered as useful.

According another advantageous feature of the invention, the coupling body can be configured with three lumen that extend adjacent one another and which are fluidly connected at their ends, wherein one lumen is configured a rinsing lumen and the two other lumens are configured as suction lumens. It can further be especially advantageous when the lumen that is configured as rinsing lumen is closed in the direction toward the wound i.e., without openings and then preferably only communicates via its distal end with the further lumens inside the coupling body. This can in a refinement of the invention—as mentioned before—advantageously be realized by a flow communication via the end cap.

For connecting the connection device to the negative pressure bandage it is advantageous that a side of the coupling body which negative pressure bandage is configured with an adhesive layer or with an adhesive coating in order to create a connection to the negative pressure bandage which is essentially negative pressure tight against the environment.

According another advantageous feature of the invention, for producing the adhesive layer or coating an at least three-layered adhesion-providing layer can be formed which has a center carrier layer, a first adhesive layer which is held on the carrier layer and faces the coupling body and a second adhesive layer which is held ion the carrier layer and faces away ford the coupling body. The adhesive providing layer is configured so that it does not block the at least one opening in the coupling body and that the first adhesive layer and the second adhesive layer are formed from different adhesive materials with different adhesive properties. In this context it is advantageous that when the coupling body is formed from silicone, the first adhesive layer includes a silicone adhesive. It is further advantageous when the second adhesive layer includes an acrylate adhesive which is then generally suited to enter into an essentially negative pressure tight connection with typical wound bandage materials. The first and the second adhesive layer have preferably a thickness of 20 to 400 μm. In the case of the center carrier layer a nonwoven, a flat material with a textile binding, for example a knitted fabric, a woven fabric or a plastic film, a metal foil or a composite material thereof is preferred. It is further advantageous when the wound facing side of the second adhesive layer is covered by a detachable protective layer which is preferably two-piece and further preferably provided with a finger tap and/or a graspable region which protrudes over the second adhesive layer.

According another advantageous feature of the invention, a connection piece, preferably made of a flexible polymeric material can be fastened to the wound-averted end of the conduit i.e., the end of the conduit which faces a negative pressure generating device, in a pressure tight and preferably materially bonding manner in particular by an adhesive connection. This connection piece can either serve for connection with a further conduit section or it servers as connecting element to a further coupling element in particular a quick coupling element or plugin connector.

The aforementioned connection piece is preferably made of a flexible polymeric material, whereby a closure member is formed, which adjoins the connection piece one-piece, and is thus securely held on the connection piece. This closure member can have one or multiple closure plug sections and close openings of the connection piece or of a quick coupling element, which can be releasably arranged on the connection piece by interference fit.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a top view on a connection device according to the invention for use in the negative pressure therapy of wounds for further connection with a not shown negative pressure generating device;

FIG. 2 shows a cross section through a conduit of the connection device according to FIG. 1;

FIG. 3 shows an enlarged perspective partial view of the connection device according to FIG. 1 with view on the wound averted side of the connection device;

FIG. 4 shows a perspective view according to FIG. 3, however without end cap;

FIG. 5 shows a perspective view of the connection device taken in the direction onto the wound facing side of the connection device however without conduit and without end cap; and

FIG. 6 shows a perspective view of the end cap.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

The Figures shown a connection device according to the invention overall designated with the reference numeral 2 for use in the negative pressure therapy of wounds. For this the connection device 2 in a manner that is to describe in more detail, is connectable with a not shown negative pressure generating device, which typically interacts with a liquid collection container for discharging and collecting of wound secrete which have been suctioned from the wound space and rinsing media. The connection device serves for the negative pressure tight coupling to a negative pressure bandage which again seals the wound negative pressure tight against the environment, wherein a negative pressure communication is established to the wound space.

The connection device 2 according to the invention includes a conduit overall designated with the reference numeral 4 and a coupling body 6. The coupling body 6 is, molded according to the invention to onto a wound side end section 8 of the conduit in a plastic injection molding process.

On a wound averted end 10 of the conduit 4 a connection piece 12 and a quick coupling element 14 for further connection in the direction toward the not shown negative pressure generating device are provided exemplary.

The coupling body 6 includes in the exemplary shown case a block shaped first region 16 which continues the longitudinal extent of the conduit 4 and a second region 18 which has a significantly smaller thickness relative to the first region and extends two dimensionally, which second region starting form the first region 16 preferably extends on both sides and further preferably on at least three sides of the first region 16, in order to realize a great contact surface of the coupling body with the not shown negative pressure bandage.

The first region 16 of the coupling body 6 includes a part 20 which at least partially surrounds the end section-8 of the conduit 4, an intermediate part 24 adjoining the part 20 in longitudinal direction 22 and an end cap 26. The part 20 which surrounds the end section, the intermediate section 24 and the two-dimensionally extending second region 18 of the coupling body 6 are produced one-piece from a flexible elastomeric material, preferably from silicone or on silicone basis. For this, the conduit 4 is introduced into a not shown injection mold and the elastomeric material which forms the coupling body is molded to the end section 8 of the conduit 4. The injection mold is configured or equipped so that the lumen 28, 30 of the conduit 4 which forms flow channels is continued inside the coupling body 6. Thus, corresponding hollow space or channel forming means, in particular in the form of rods or the like have to be provided in the injection molding tool. Even though not shown, it would also be conceivable that the conduit 4 or its end section 8 extends up to the end cap 26. In this case the part 20, which at least partially surrounds the end section 8 of the conducting, means 4 in longitudinal direction 22 would be configured longer and the intermediate part 24 would not be required or be configured much shorter. However, it has proven advantageous when the conduit 4 only protrudes into the coupling body 6 with a relatively short end section 8 because in this case the freedom of design of the coupling body 6 inside the intermediate part 24 is greater and openings 32 can be formed in a walling 34 of the coupling body 6 already during the injection molding process which walling faces the negative pressure bandage.

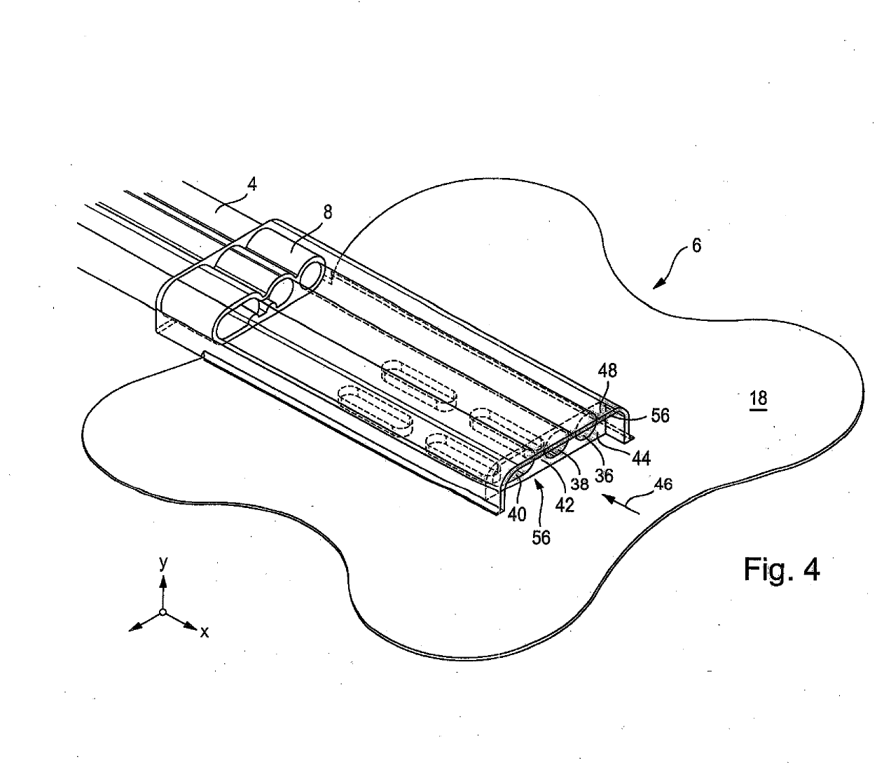

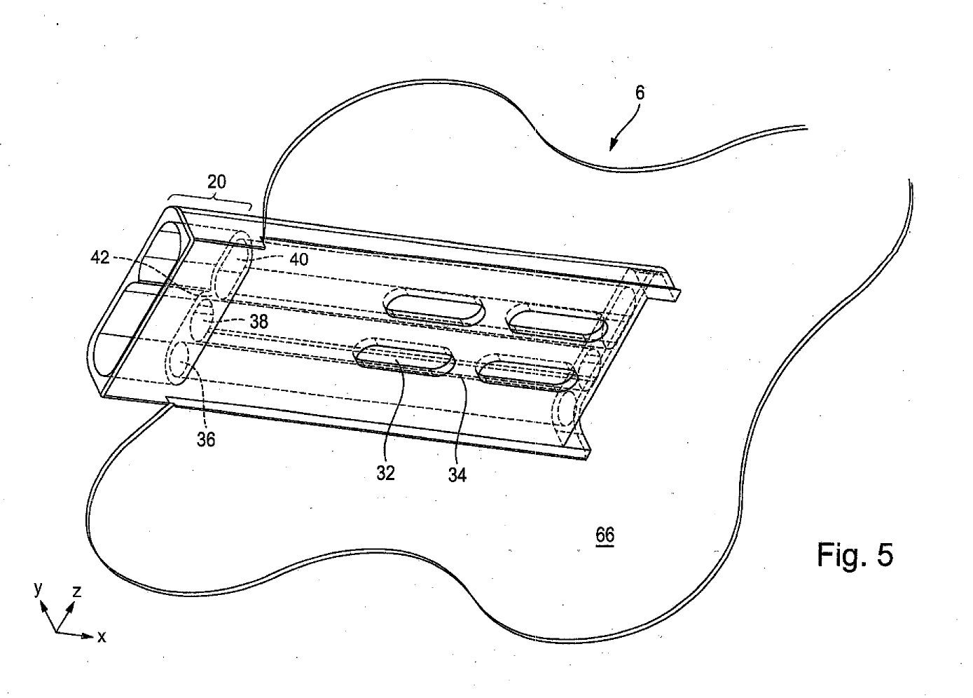

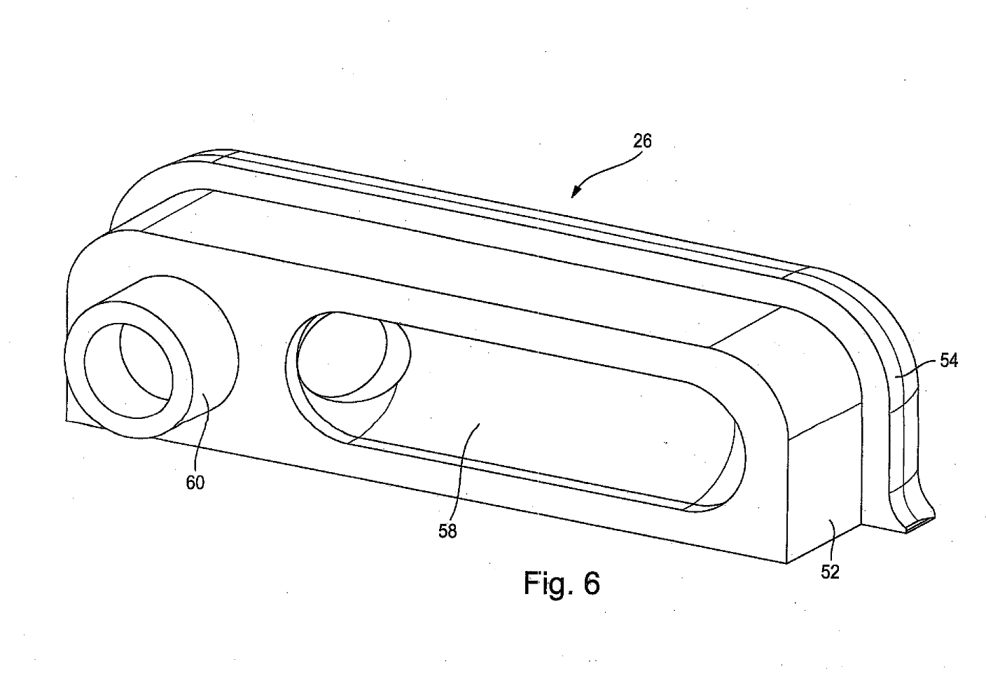

The intermediate part 24 is thus formed with lumens 36, 38, 40 in its interior which are separated from each other transverse to the longitudinal direction 22 and which as can be seen from the Figures, adjoin the lumens 28, 30 of the conduit. The lumen 30 of the conduit 4 can be configured with a much greater cross section than the lumen 28; it includes in a certain sense two partial cross sections which are designated with the reference sings 30a and 30b which are however not completely fluidly separated from each other. They are delimited by longitudinal ribs 41 in the interior of the conduit 4 which prevent a collapsing of the lumen 30. The lumens 38 and 40 inside the intermediate part 24 which adjoin the lumen 30 or the partial cross sections 30a, 30b of the conduit of the coupling body 6 are however separated from each other by a walling 42 which is formed from the material of the intermediate part 24 (which can be best seen in the FIGS. 4 and 5). This separated configuration is preferred, however not strictly required. This provides the advantage that the stability of the coupling body 6 against collapsing of its lumens 36, 38, 40 is increased and that its rinsability with rinsing media is improved.

FIG. 4 shows the conduit 4 with the molded on, i.e. one-piece coupling body 6 after the injection molding process i.e., still without end cap 26. FIG. 5 shows the coupling body 6 again without end cap 26 and without conduit 4, i.e., in a not existing state only for illustrating the part 20 of the coupling body, which part 20 surrounds the end section 8 of the conduit 4.

It can further be seen best from FIG. 4 that the lumens 36 38, 40 of the coupling body end freely on a front side 44 of the intermediate part 24 which front side faces the end cap 26. They are closed negative pressure tight against the environment by negative pressure tight attachment of the end cap 26. The end cap which is attached by interference fit or preferably non-detachably in a materially bonding manner in particular by means of glue, completes the coupling body 6 of the connection device 2 according to the invention. As can be further best seen from FIG. 4, a border region 48 is formed during molding-on of the material which forms the coupling body 6, which border region 48 extends in opposite direction of an attachment direction 46 of the end cap 26, and which is preferably relatively thin for example only 0.5 to 1.5 mm thick and delimits a receiving opening 50 of the end cap 26. In the exemplary shown case, the border region 48 extends over three sides so that the receiving opening 50 is delimited on the fourth side by the two-dimensionally extending second region 18 of the coupling body 6.

The end cap 26, which is preferably made of the same material as the coupling body, is shown in FIG. 6 in a perspective view. An engagement section 52 can be seen with which the end cap 26 engages in the receiving opening 50 and a section 54 which is visible from the outside and which completes the coupling body 6 in an outwardly visible manner. The end cap 26 is preferably, however not necessarily, configured so that the visible section 54 protrudes relative to the engagement section 52 just by the thickness of the protruding border region 48 of the intermediate part 24. This results in a further labyrinth-like sealing and in addition an essentially groove-free, step-free transition from the intermediate part 24 to the end cap 26 can be realized.

The end cap 26 is further configured with a recess, overall designated with the reference numeral 58, by means of which a flow communication between at least two, in the exemplary shown case between all three lumens 36, 38, 40 is achieved i.e., starting from their distally ending openings in the region of the front side 44. The recess 58 may be realized in multiple ways, in the simplest case for example in the form of an oblong hole shaped indentation which then adjoins the front side 44 of the intermediate part 24. In the exemplary shown concrete case, the end cap is formed with a tubular attachment 60 which when attaching the end cap 26, sealingly engages in the lumen 36 in the intermediate part which lumen is configured complementary to the attachment 60. This tubular attachment leads in the interior of the end cap 26 into the transverse extending recess 58, which opens to the front side 44 of the intermediate part 24 in the manner of an oblong hole. In this way, a flow communication is established between all lumens 36, 38, 40.

In the exemplary shown case it is advantageous that the lumen 28 of the conduit and the lumen 36 adjoining the lumen 28 are configured inside the coupling body 6 as rinsing lumens for delivering a fluid medium in the direction toward the wound. Rinsing fluid or other fluids, in particular air are in this way conducted to the distal end openings of the lumens 38, 40 in the front side of 44 of the intermediate part 24. This enables a dead space free rinsing; thus no line section exists that would not be immediately exposed to the flow which is considered especially beneficial with regard to the intended function of the connection device and the negative pressure therapy performed with it and with regard to reducing bacterial growth and infections. The end cap therefore has a dual function, i.e., on one hand it completes the coupling body 6 and closes the openings of the lumens 36, 38, 40 which after the injection molding process open to the outside, and on the other hand a flow communication is realized by the end cap 26 between the lumens 36, 38, 40.

For negative pressure communication with the wound space, the already mentioned openings 32 are formed in the walling 34 of the coupling body which walling 34 faces the negative pressure bandage. It can be seen from the Figures that the lumen 36 of the coupling body which functions as rinsing lumen does not have such an opening which is preferred however not required. The openings 32 which are provided in the region of the longitudinal extent of the lumens 38, 40 are preferably shaped as oblong holes and have for example a length of 8 to 12 mm. In the exemplary shown case, two such oblong hole shaped openings are formed along the extent of each lumen 38, 40. During use, the lumens 38, 40 of the coupling body communicate with the wound space via these openings 32 and through at least one opening in the negative pressure bandage. Typically, the lumens 38, 40 of the coupling body 6 are impinged with negative pressure via the lumen 30 in the conduit 4; the lumens 38 40 thus typically function as suction lumens for applying negative pressure and for discharging of wound secrete, rinsing fluids or other supplied fluid media.

In the following, the shape of the two-dimensionally extending second region 18 of the coupling body which region is exemplary shown in the Figures is described. When viewed from the top, this shape or form can best be described as butterfly like, because this second region 18 when viewed in longitudinal direction 22 has a constriction 62 on either side. In this way, the dimensions of the coupling body 6 or its second region 18 along outlined diagonals 64, which form an angle of about 45° to the longitudinal direction 22 are greater than in the longitudinal direction 22 and perpendicular thereto. In the exemplary shown and preferred case, the two-dimensionally extending and thin second region 18 extends toward three sides past the also rather flat but bloc-shaped first region 16 of the coupling body 6. In this way a very good connection to a not shown negative pressure bandage can be achieved because the occurring forces are distributed across a large surface and can therefore be conducted into the regions of the wound bandage which surround the wound and the body surface of the patient without local force peaks.

For connection to the negative pressure bandage, the coupling body includes on its side 66, which faces the negative pressure bandage, a not shown adhesive layer. This adhesive layer is preferably configured as an at least three-layered adhesion-providing layer which includes a center carrier layer, a first adhesive layer held on the carrier layer and facing the coupling body, and a second adhesive layer held on the carrier and facing away from the coupling body. The adhesive layers are each configured so as to be optimized with regard to forming an adhesive connection with the material of the coupling body or with the material of the negative pressure bandage. With regard to further materials of this at least three-layered adhesion providing layer reference is made to the non pre published DE 10 2011 108 726.9 whose subject matter is herewith incorporated by reference into the present application.

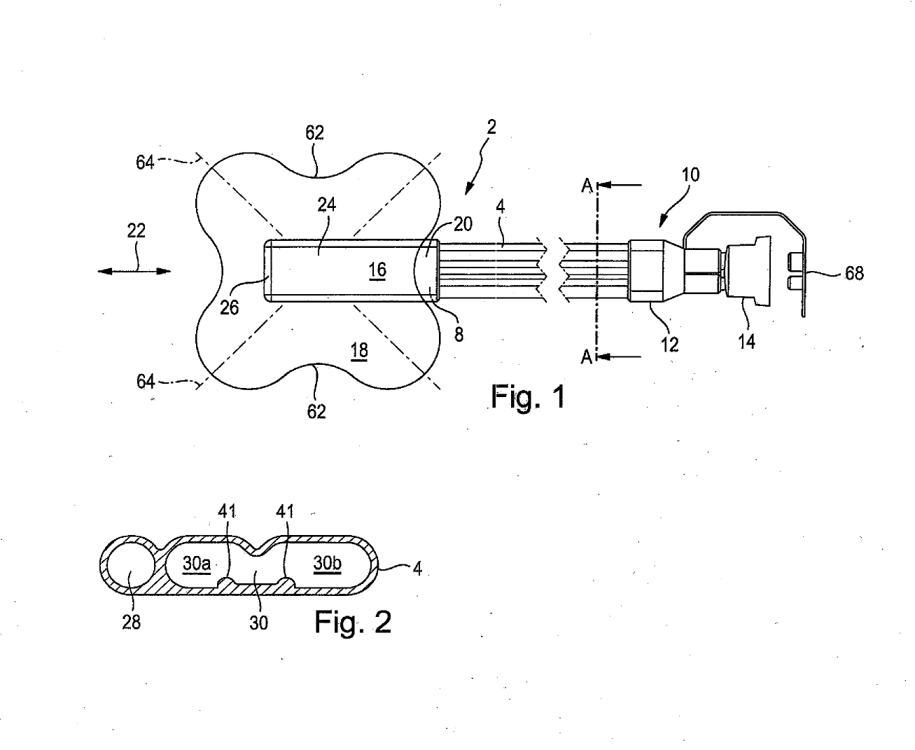

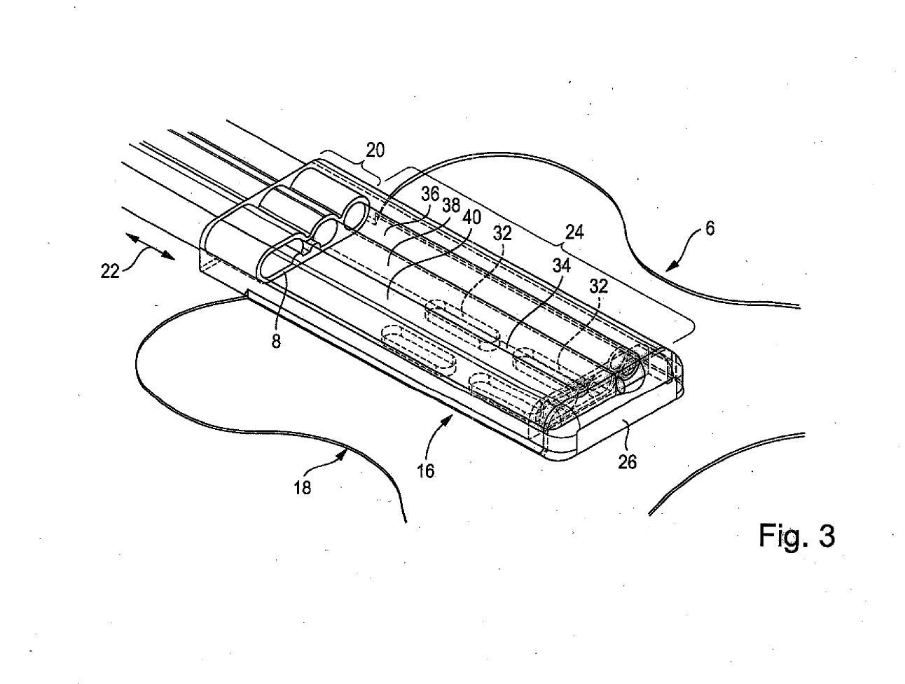

Finally, FIG. 1 shows on the wound-averted end 10 of the conduit the connection piece 12 which is preferably formed from a flexible polymeric material and joined in a negative pressure tight and preferably materially bonding manner to the wound-averted end 10 of the conduit 4. The connection piece 12 includes a closure member 68 which preferably adjoins the connection piece in one-piece and is therefore securely held on the connection piece 12 and which is capable of closing openings of the connection piece 12 or of a quick coupling element 14 which can be releasably arranged on the connection piece by interference fit. The connection piece 12 is preferably an injection molding part, which is produced one-piece together with the closure member 68. A further connection means section can be connected to the quick coupling element 14 which leads to the not shown negative pressure generating device with liquid collection container via a complementary configured quick coupling element in a negative pressure tight manner.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for producing a connection device for use in the negative pressure therapy of wounds, comprising:
introducing a flexible conduit into an injection mold, the conduit being constructed for impingement with negative pressure and/or fluid media, and comprising at least two lumens;
forming a coupling body at an end section of the conduit by injection molding an elastomeric material to the end section of the conduit, said coupling body being constructed for attachment to a negative pressure bandage which covers the wound and seals the wound tight against the environment, said conduit being constructed for communication with the wound space through at least one opening; and
attaching and fastening an end cap to the coupling body, thereby sealing the coupling body tight to the outside.

2. The method of claim 1, wherein the conduit is formed by extrusion.

3. The method of claim 1, wherein the conduit is introduced in the injection mold so as to lead to the coupling body essentially parallel to a two-dimensional extent of the coupling body.

4. The method of claim 1, wherein the elastomeric material is injection molded to the end section of the conduit so that the coupling body is provided with lumens and at least one of the lumens of the coupling body ends freely after the coupling body is injection molded to the end section of the conduit, and wherein the at least one freely ending lumen of the coupling body is sealed tight against the outside by fastening of the end cap.

5. The method of claim 4, wherein the elastomeric material is injection molded to the end section of the conduit so that at least two of the lumens of the coupling body end freely after the coupling body is injection molded on the end section of the conduit, and wherein the at least two freely ending lumens are closed tight to the outside and are fluidly connected to each other by a recess of the end cap.

6. The method of claim 1, wherein at least one member selected from the group consisting of the conduit, the coupling body and the end cap is made of a flexible elastomeric material, in particular from silicone or on silicone basis, with a Shore—A hardness of at most 65, in particular at most 60, in particular at most 50, in particular at most 40 and of at least 10 in particular of at least 15.

7. The method of claim 1, wherein the end cap is materially bonded with the injection molded material of the coupling body, in particular by gluing.

8. The method of claim 1, wherein in the injection molding step a preferably thin border region is formed in which the end cap is inserted and which then surrounds the end cap collar-like in a circumferential direction.

9. The method of claim 1, wherein the coupling body is formed with a first region which includes a first part which at least partially surrounds the end section of the conduit, an intermediate part adjoining the first part, and the end cap, and with a second region which has a smaller thickness than the first region and has a two-dimensional extent.

10. The method of claim 9, wherein the second region is formed with a thickness of 0.1-1.0 mm, in particular of 0.1-0.8 mm, in particular of 0.1-0.5 mm.

11. The method of claim 9, wherein the second region is configured so that a contact surface of the second region with a wound-averted top side of the negative pressure bandage is at least 1.5 times, in particular 1.8 times greater than a contact surface of the first region with the wound-averted top side of the negative pressure bandage.

12. The method of claim 9, wherein the first region is formed with a maximal thickness which is at most 3 mm, in particular at most 2 mm greater than the thickness of the conduit and in that the first region is formed with a maximal width which is at most 5 mm in particular at most 3 mm in particular at most 2 mm greater than the width of the conduit.

13. The method of claim 9, wherein a thickness extent of the conduit is at most 7 mm, in particular at most 6 mm, in particular at least 3 mm and further in particular 4-6 mm, wherein a width of the conduit transverse to a longitudinal extent of the conduit is at least 12 mm, in particular at least 15 mm, in particular between 15 and 30 mm in particular between 15 mm and 25 mm, in particular between 15 and 22 mm.

14. The method of claim 9, wherein in the injection molding step, two of the at least two lumens or sub sections of one of the at least two lumens are not separated from each other in a negative pressure tight manner, and are sealed pressure tight against each inside the coupling body transverse to a longitudinal extent of the at least two lumens or sub sections of the one of the at least two lumens.

15. The method of claim 1, wherein the coupling body is formed with three adjacently extending lumens having respective ends, and are fluidly connected to each other at their respective ends, wherein one of the three lumens is configured as rinsing lumen and the two other ones of the three lumens are configured as suction lumens.

16. The method of claim 1, wherein a side of the coupling body which faces the negative pressure bandage is configured with an adhesive layer, to form an adhesive connection with the negative pressure bandage, which is essentially negative pressure tight against the environment.

17. The method of claim 16, wherein for generating the adhesive layer or coating an at least three-layered adhesion providing layer is formed which has a center carrier layer, a first adhesive layer which is held on the carrier layer and faces the coupling body and a second adhesive layer which is held on the carrier layer and faces away from the coupling body, wherein the adhesion providing layer is configured so that it does not block the at least one opening in the coupling body, and wherein the first adhesive layer and the second adhesive layer are made of different adhesive materials having different adhesive properties.

18. The method of claim 1, further comprising a connection piece fastened preferably materially bonded on a wound-averted end of the conduit in a negative pressure tight manner, in particular by an adhesive connection, said connection piece preferably being made of a flexible polymeric material.

19. The method of claim 18, wherein the connection piece is pre-formed from a flexible polymeric material in one-piece together with a closure member adjoining the connection piece said closure member being securely held on the connection piece, and constructed for closing openings of the connection piece or of a quick coupling element which is detachably arrangable on the connection piece by interference fit.
